(19) United States
(12) Patent Application Publication
(10) Pub. No.: US 2002/0017355 A1
(43) Pub. Date: Feb. 14, 2002

(54) Heating-element in a welding device and method for heating

(76) Inventors: Jorg Wermelinger, Schaffhausen (CH); Sven Hoffmann, Schaffhausen (CH)

Correspondence Address: Gregory P.LaPointe, BACHMAN & LaPOINTE P.C., Suite 1201, 900 Chapel Street, New Haven, CT, 06510-2802, US

(21) Appl. No.: 09/885,510

(22) Filed: Jun. 20, 2001

(30) Foreign Application Priority Data
Jul. 20, 2000 (DE) 100 35 695 8

(51) Int. Cl. B32B 31/00; H05B 3/58; B29C 31/00

(52) U.S. Cl. 156/64; 219/535; 219/544; 156/503

(57) ABSTRACT

A heating-element in a welding device for heating up plastic molded parts region by region during the welding operation is proposed, comprising at least two shell-shaped heating elements (2, 3) resting on the outside on the plastic molded parts in the region of the weld, the heating elements being of a rotationally symmetrical design, each heating element (2, 3) having a central region (7) and two edge regions (8, 9) arranged adjacently on both sides of the central region in the axial direction and designed in an axially symmetrical manner, and the edge region being formed from a material which has a lower thermal conductivity than the material of the central region.

### BACKGROUND OF THE INVENTION

The invention relates to a heating-element in a welding device for heating up plastic molded parts region by region during the welding operation, comprising at least two shell-shaped heating elements resting on the outside on the plastic molded parts in the region of the weld, the heating elements being of a rotationally symmetrical design. The invention also relates to a method for heating up plastic molded parts region by region.

In pipeline construction, plastic molded pipe parts, such as pipe bends and pipe branches for example, are being increasingly used and are welded to one another on the construction site. The plastic molded pipe parts are worked at right angles and in a planar manner and are aligned axially in relation to one another in a special welding device and fixed. The pipe ends are heated up and pressed axially together. During the welding operation, the plastic molded pipe parts are firmly held on the welding device by clamping systems.

U.S. Pat. No. 4,801,349 discloses a method and a device for the butt-welding of plastic molded pipe parts. The device comprises two electrically heated heating elements, which are applied to the welding point on the outside in a shell-shaped manner. The lower heating element is designed differently from the upper heating element and has a convexly curved surface. The fixing devices are represented as separate elements of the welding devices. For accurate working during welding, all the elements must be precisely aligned in the axial direction, which becomes more difficult as the number of elements increases and as the distance between the elements increases.

It is an object of the invention to specify a heated-element welding device for heating up plastic molded parts region by region which can be easily produced from individual parts which differ as little as possible and which keeps even the smallest plastic molded parts precisely aligned with one another during welding in an extremely confined space.

### SUMMARY OF THE INVENTION

The foregoing object is achieved by providing a heating-element in a welding device for heating up plastic molded parts region by region during the welding operation, comprising at least two shell-shaped heating elements resting on the outside on the plastic molded parts in the region of the weld, the heating elements being of a rotationally symmetrical design, each heating element having a central region and two edge regions arranged adjacently on both sides of the central region in the axial direction and designed in an axially symmetrical manner, and the edge region being formed from a material which has a lower thermal conductivity than the material of the central region.

It is advantageous that the heating-element can be produced easily and without the formation of radially formed convex curvatures. This is achieved by the edge region being of an annular design, being arranged with a circular inner surface resting on the plastic molded parts and comprising a connecting region for connection to the central region, a transitional region and a fastening region for fastening on a further structural element of the welding device. This is achieved by the edge regions being arranged such that they can be connected to the central region by clamping, welding or adhesive bonding.

It is also advantageous that the heating-element can be used for supplying the heat necessary for the welding to the welding point in as specifically directed a manner as possible and without energy losses. This is achieved by the transitional region having a wall thickness D which is less than 10% of the length L of the transitional region. This is achieved by the wall thickness D of the transitional region being less than 1 mm. This is further achieved also by the material of the central region having a thermal conductivity which is at least 25 times as high as that of the material of the edge region. For this purpose, it is advantageous if the edge region is formed from ceramic or from high-alloy steel.

The far inferior thermal conductivity of those regions which are not directly necessary for the welding operation and the much thinner wall thickness of the transitional region have the effect that the amount of heat which is lost by heat conduction is significantly restricted. A special heating-up method, in which the upper heater and the lower heater are activated differently by a computer system, achieves the effect that the welding point has the same welding temperature all round.

### BRIEF DESCRIPTIONS OF THE DRAWINGS

An exemplary embodiment of the invention is described with reference to the figures in which:

FIG. 1 shows a section view of a heating element welding device according to the invention taken along line 1-1 of FIG. 2 and

FIG. 2 shows a section through the heating-element welding device from FIG. 1 taken along line 2-2.

### DETAILED DESCRIPTION OF THE DRAWINGS

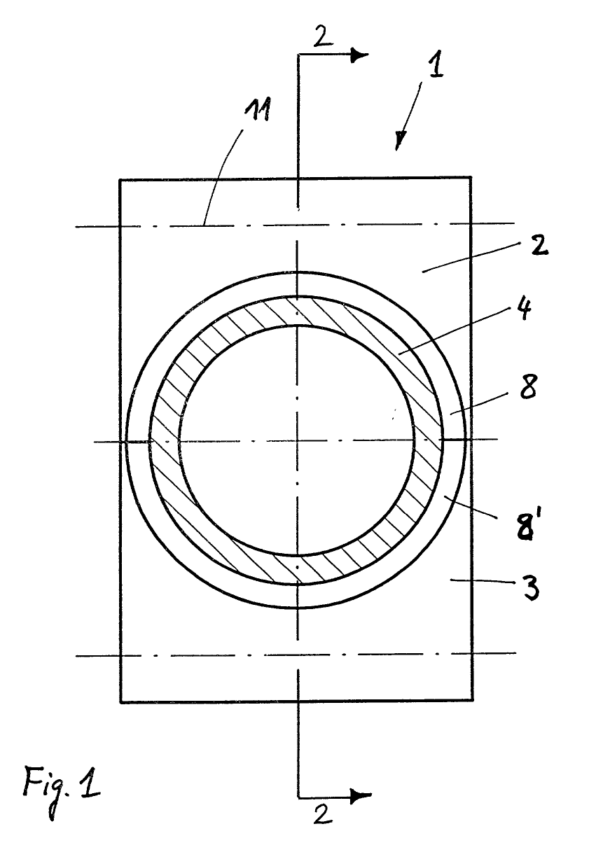

A view of a heating-element used in a welding device 1 for heating up plastic molded pipe parts region by region is schematically represented in FIG. 1. The heating-element 1 is part of a larger installation, on which the plastic molded pipe parts, such as for example pipe ends, pipe bends and pipe branches, can be connected to one another by welding. In FIG. 1, the view of the heating-element 1 in the direction of the pipeline axis is represented. The heating-element 1 essentially comprises an upper heating element 2 and a lower heating element 3, which together enclose two pipe pieces 4, 5, of which only the section can be seen in FIG. 1, in a semicircular and shell-like manner. The upper heating element 2 and the lower heating element 3 are usually arranged in a two-part heating station which can be swung open. The two parts of the heating station are then connected to each other by means of a hinge, which is not represented here.

The heating station may be arranged displaceably on rails in the axial direction in the welding device as is known in the art and can consequently be aligned with the welding point of the molded pipe parts which have to be welded to one another. In relatively small, portable welding devices, the heating station may be in a fixed arrangement. The pipe ends must then be introduced into the heating station from both sides. The pipe ends are introduced into the heating station from both sides in the axial direction to the extent that the welding point comes to lie exactly midway between the heating elements 2, 3. Before introducing them into the welding device, the pipe ends must be cut off at right angles and worked in a planar manner. Following this pipe working or pipe preparation, the pipe ends or the plastic molded pipe parts are aligned exactly with one another and fixed in the welding device before the actual welding operation.

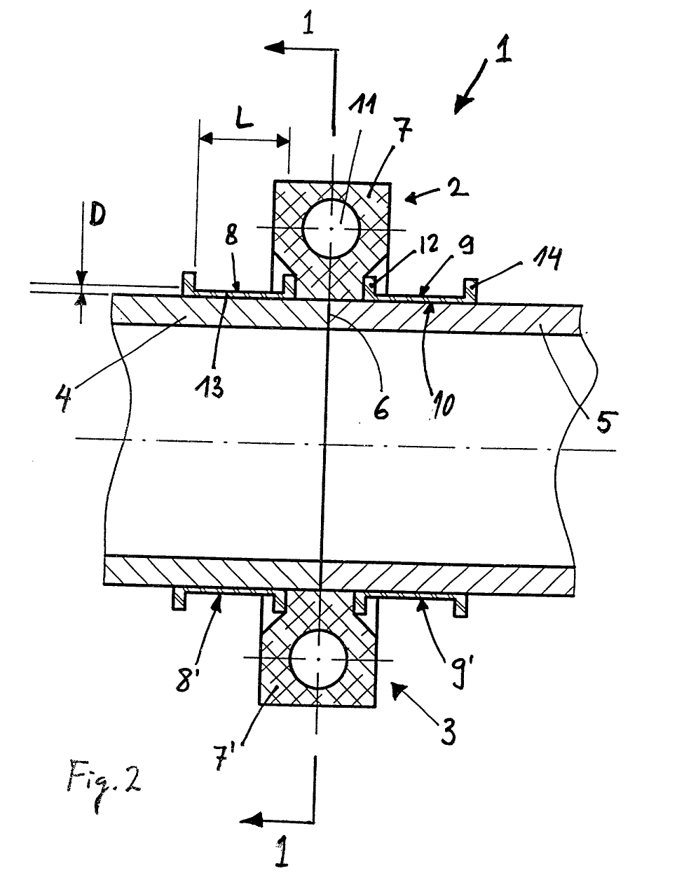

In FIG. 2, a section through the heating-element 1 from FIG. 1 is represented. For the sake of better overall clarity, only the heating elements 2, 3 are represented in FIG. 2, without further parts, such as for example the rails and the clamping elements and further fastening elements or structural elements of the welding device. Two pipe pieces 4, 5 with a welding point 6 are also represented in FIG. 2. The upper heating element 2 and the lower heating element 3 are identically designed and mutually exchangeable components, which are fastened in the heating station. Each heating element 2, 3 comprises a central region 7, 7′ and two edge regions 8, 8′, 9, 9′. Both the central regions 7, 7′ and the edge regions 8, 8′, 9, 9′ are of an annular design and have an inner surface 10, which encloses the pipe pieces 4, 5 in a circular manner. The inner surfaces of the edge regions 8, 8′, 9, 9′ have the same inside radius as the inner surfaces of the central regions 7, 7′. The combination of the heating elements 2, 3 consequently has a relatively long and constant tubular inner surface 10, which can be easily produced and facilitates the alignment of the two pipe pieces 4, 5. The edge regions 8, 9 are of a much lower weight than the central region 7. Formed in the central region 7 is a bore 11, which is intended for receiving an electrical heating cartridge, for example a resistance heater. The bores 11 and also the heating cartridges in the upper heating element 2 and lower heating element 3 are identically designed. In order that the heating in the upper heating element 2 and in the lower heating element 3 can be differently controlled and regulated, the heaters are connected independently of each other to a heating regulating system, for example a computer. Temperature measuring probes (not shown) are also arranged in the upper heating element 2 and in the lower heating element 3 in order to sense the temperature of the upper and lower heating elements separately.

The edge regions 8, 9 are designed in an annular and flange-like manner and comprise one after the other, as seen from the central region 7, a connecting region 12, a transitional region 13 and a fastening region 14. The connecting region 12 has a flange for the connection to the central region 7. The connection of the edge region 8, 9 to the central region 7 of the heating element 2, 3 can be established by clamping, welding, soldering or adhesive bonding. With the chosen method of connection, it is important that as little heat as possible can dissipate via the connecting surface between the central region 7 and the connecting region 12 of the edge region 8, 9. The transitional region 13 has a relatively large length L and has a relatively small wall thickness D. The wall thickness D of the transitional region 13 is preferably less than 10% of the length L. To restrict the heat flow through the transitional region 13 as far as possible, the wall thickness is chosen to be less than 1 mm. With this arrangement, providing adequate strength of the heating element, as little heat loss as possible occurs from the central region to the edge region.

The heat loss is further restricted if the materials of the edge region 8, 9 and of the central region 7 are chosen such that the thermal conductivity of the edge region 8, 9 is at least twenty-five times less than the thermal conductivity of the central region 7. The central region 7 may be produced from a metal which conducts heat relatively well, such as copper or silver for example, and the edge regions 8, 9 may be produced from a material which conducts heat relatively poorly, such as high-alloy steel or ceramic for example.

Further structural elements (not represented) of the welding device may be fastened to the flange-like fastening region 14. For example, a clamping device or a fastening means on the housing of the welding device may be fastened here. This achieves the effect that as little heat as possible dissipates into the remaining structure of the welding device. A compact arrangement of the heating elements and clamping elements is also achieved in this way. The most compact arrangement possible is advantageous for using the welding device in constricted spaces and when pipes of relatively small length have to be welded together.

In particular in the case of relatively large pipeline diameters, non-uniform temperature conditions are often observed. Convection causes heat to be brought from the lower heating element 3 into the operating range of the upper heating element 2. This leads to a higher temperature at the welding point 6 in the region of the upper heating element 2. This difference in temperature can be seen on the pipeline once it has been welded from the way in which the welding point 6 is formed differently in certain regions. The region which was melted on both sides of the welding point 6 may have a different width. The melting zones which occur during heating up may have a different width. As a result, a weak point may be created in the material of the pipeline. The strength of the plastic molded part in the region of the welding point may be adversely influenced. A special method can be used during the heating-up operation to prevent the welding temperature from becoming too high in the region of the upper heating element 3.

In the welding method, a distinction is drawn between a heating-up phase, a welding phase and a cooling-down phase. During the heating-up operation, the heating elements 2, 3 are brought to the welding temperature. The upper heating element 2 and the lower heating element 3 are designed for the same electrical power. During the heating-up operation, the temperature is measured at temperature measuring probes in the upper heating element 2 and in the lower heating element 3 at fixed time intervals, for example once every 0.5 second, and are stored in a computer. A temperature-time curve is recorded in the computer for each heating element 2, 3. The temperature-time curve of the upper heating element 2 has a greater slope than that of the lower heating element 3. The computer can calculate the different slope of the temperature-time curves. On the basis of this different slope, the computer can regulate the energy supply to the upper heating element 2, for example by restricting the electrical power or by a shorter operating time of the upper heating element 2. This achieves the effect that the slope of the two temperature-time curves is made to match already during the heating-up phase. Even if the position of the lower heating element 2 and upper heating element 3 is changed over, for example if the welding device is used in a laterally inverted way, the computer can detect on the basis of the greater slope which heating element is arranged at the top. This achieves the effect that, at the end of the heating-up operation, the welding temperature in the region of the upper heating element 2 and lower heating element 3 is reached at the same point in time. The differences described above, brought about by the different heat absorption in the region of the upper heating element 2 and of the lower heating element 3, may be virtually negligible if the time of the interval between the measuring and regulating operations is chosen to be sufficiently short. The heating-element 1 and the method for heating up region by region are used in pipeline construction, in particular for the welding of differently shaped pipe parts made of plastic. The welding processes for which the method is used are generally referred to as butt welding processes and in particular as bulge-and groove-free welding processes.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. In a welding device for welding plastic molded parts at a weld region, a heating-element for heating up the plastic molded parts region by region during the welding operation, comprising at least two shell-shaped heating elements resting on the outside on the plastic molded parts in the region of the weld, the heating elements being of a rotationally symmetrical design, wherein each heating element has a central region and two edge regions arranged adjacently on both sides of the central region and extend in an axial direction from the weld region along the plastic molded part, the heating element is designed in an axially symmetrical manner, wherein the edge region is formed of a material which has a lower thermal conductivity than the material of the central region.

2. The welding device as claimed in claim 1, wherein the edge regions are of an annular design, being arranged with a circular inner surface resting on the plastic molded parts and include a connecting region for connection to the central region, a fastening region for fastening on a further structural element of the welding device and a transitional region between the connecting region and the fastening region.

3. The welding device as claimed in claim 2, wherein the transitional region has a wall thickness D which is less than 10% of the length L of the transitional region.

4. The welding device as claimed in claim 3, wherein the wall thickness D of the transitional region is less than 1 mm.

5. The welding device as claimed in claim 1, wherein an independent electrical heater is arranged in the central region of each heating element which rests on the region of the weld below and above the plastic molded part.

6. The welding device as claimed in claim 1, wherein the material of the central region has a thermal conductivity which is at least 25 times as high as that of the material of the edge region.

7. The welding device as claimed in claim 1, wherein the edge region is formed of material selected from the group consisting of ceramic and high-alloy steel.

8. The welding device as claimed in claim 1, wherein the edge region is formed from a material which has a lower thermal conductivity and a higher mechanical strength than the material of the central region.

9. The welding device as claimed in claim 1, wherein the edge regions are connected to the central region by one of clamping, welding and adhesive bonding.

10. The welding device as claimed in claim 1, wherein the plastic molded parts are plastic pipe parts.

11. A method for heating up plastic molded parts region by region with a welding device as claimed in any one of the proceeding claims, comprising heating up to the welding temperature, measuring as a function of time, the temperature values of each heating element lying below and above the plastic molded pipe parts, evaluating by computer the measured temperature values and regulating the energy supply to each heating element independently in such a way that, at the end of the heating-up operation, the lower heater has the same welding temperature as the upper heater.

12. A heating-element comprising at least two shell-shaped heating elements of a rotationally symmetrical design, wherein each heating element has a central region and two edge regions arranged adjacently on both sides of the central region and extending axially in opposed directions, the edge region being formed of a material which has a lower thermal conductivity than the material of the central region.

13. The heating-element as claimed in claim 12, wherein the edge region is of an annular design and comprises a connecting region for connection to the central region, a fastening region for fastening on a further structural element and a transitional region between the connecting region and the fastening region.

14. The heating-element as claimed in claim 13, wherein the transitional region has a wall thickness D which is less than 10% of the length L of the transitional region.

15. The heating-element as claimed in claim 14, wherein the wall thickness D of the transitional region is less than 1 mm.

16. The heating-element as claimed in claim 12, wherein an independent electrical heater is arranged in the central region of each heating element.

17. The heating-element as claimed in claim 12, wherein the material of the central region has a thermal conductivity which is at least 25 times as high as that of the material of the edge region.

18. The heating-element as claimed in claim 12, wherein the edge region is formed of material selected from the group consisting of ceramic and high-alloy steel.

19. The heating-element as claimed in claim 12, wherein the edge region is formed from a material which has a lower thermal conductivity and a higher mechanical strength than the material of the central region.

20. The heating-element as claimed in claim 12, wherein the edge regions are connected to the central region by one of clamping, welding and adhesive bonding.
